(19) United States
(12) Patent Application Publication
(10) Pub. No.: US 2015/0262164 A1
(43) Pub. Date: Sep. 17, 2015

(54) CLOUD-BASED SECURE STORAGE

(71) Applicant: GOOGLE INC., Mountain View, CA (US)

(72) Inventors: Balamourougan Ranganathan, Cummings, GA (US); Yale P. Vinson, Flower Mound, TX (US); Bart S. van Hoek, Dallas, TX (US); Chirag Bhalani, Plano, TX (US); Weimin Tsai, Irving, TX (US); Nilesh B. Pusuluri, Flower Mound, TX (US); Hiteshkumar M. Shah, Plano, TX (US); Danny Sung, Arlington, TX (US)

(21) Appl. No.: 14/657,882

(22) Filed: Mar. 13, 2015

Related U.S. Application Data
(60) Provisional application No. 61/952,459, filed on Mar. 13, 2014.
(60) Provisional application No. 61/952,451, filed on Mar. 13, 2014.
(60) Provisional application No. 61/952,471, filed on Mar. 13, 2014.

(51) Int. Cl. G06Q 20/32

(52) U.S. Cl. CPC G06Q 20/3278; G06Q 20/322

(57) ABSTRACT

System, methods, and computer program products are provided for interfacing with and providing a cloud-based secure storage. A payment system and procedure optionally stores security-critical information in a cloud-based secure store. Personalization data on the cloud-based secure store may be comprehensively managed by interfacing with a contactless front end (CLF) module in a near field communication (NFC) device and an interceptor. Non-security-critical information remains on the device. The processing time required to manage a payment transaction using Host-based Card Emulation (HCE) is minimized. User experience is improved.

### CROSS REFERENCE TO RELATED APPLICATION

This application claims priority to U.S. Provisional Patent Application No. 61/952,459 filed Mar. 13, 2014, U.S. Provisional Patent Application No. 61/952,471 filed Mar. 13, 2014, and U.S. Provisional Patent Application No. 61/952,451 filed Mar. 13, 2014, the entire contents of which are hereby fully incorporated herein by reference.

### BACKGROUND

1. Field

The present invention relates to mobile networks, and more particularly to systems, methods, and computer program products for interfacing with and providing a cloud-based secure storage.

2. Related Art

A service provider (SP) is a company, organization, entity, or the like, that provides services to customers or consumers. Examples of service providers include account-issuing entities such as merchants, card associations, banks, marketing companies, and transit authorities. A service may be an activity, capability, functionality, work, or use that is permitted or provided by a service provider such as a payment service, a ticketing service, a gift, offer or loyalty service, a transit pass service, and the like. A service may be used via a mobile device, for example, by utilizing one or more applets that make up that service.

In a mobile environment that involves contactless transactions between mobile devices and service providers, information relating to the accounts and applets issued by the service providers is downloaded onto mobile devices in order to enable them to perform the contactless transactions.

A trusted service manager (TSM) is typically an independent entity serving mobile network operators (MNOs) and account-issuing service providers, for example, by provisioning applets, such as contactless applets associated with the service providers, to mobile devices. Typical TSMs can distribute and manage the contactless applets remotely because they have access to secure elements (SEs) associated with a near field communication (NFC) enabled mobile device.

A secure element is a platform onto which applets can be installed, upgraded, and managed. It consists of hardware, software, interfaces, and protocols that enable the secure storage of data such as credentials, and execution of applets for payment, authentication, and other services. An applet or set of applets may correspond to a service (e.g., payment, commerce, ticketing) offered by a service provider.

The secure element may be implemented in different form factors such as a Universal Integrated Circuit Card (UICC), an embedded secure element, or NFC enablers such as a separate chip or secure device, which can be inserted into a slot on the mobile device. Typically a UICC is in the form of a subscriber identity module (SIM), which is controlled by the MNOs. An embedded secure element gives service providers the option to embed the secure element into the phone itself. One way in which secure element form factors are implemented is defined, for example, by GlobalPlatform, such as in GlobalPlatform Card Specification Versions 2.1.1, 2.2, and 2.2.1 (hereinafter “Global Platform”).

The secure element may also be implemented outside of the mobile device with which it may be associated with. For example, such a secure element may be implemented in cloud-based, remote or virtual storage, and the like.

The secure element may include one or more security domains (SDs), each of which includes a collection of data, such as packages, applets, and the like, that trust a common entity (e.g., are authenticated or managed by using a common security key or token).

Security domains may be associated with service providers and may include service provider applets such as loyalty, couponing, credit card, and transit applets.

A Contactless Frontend (CLF) is circuitry which handles the analog aspect of contactless or NFC communications and the communication protocol layers of a contactless transmission link.

An NFC-enabled contactless payment device can function as a credit card to enable purchases at a point of sale (POS) (e.g., at a bricks-and-mortar store).

Host-based Card Emulation (HCE) architecture includes the presentation of a virtual representation of a UICC using only software.

A Proximity Payment System Environment (PPSE) applet serves as an application used to maintain a directory of available credentials. Each payment credential is assigned a corresponding application identifier (AID) associated with a payment application. The PPSE applet provides accessibility to each payment application stored on the mobile device by making them visible or not visible (i.e., accessible) to systems or devices.

A central TSM is a system for interfacing (e.g., communicating, beginning a dialog) service providers and secure elements, for example for service providers to upgrade services on a secure element, transmit scripts to be processed, and the like. An exemplary embodiment of a central TSM for managing communications between service providers and secure elements is described in more detail in U.S. patent application Ser. No. 13/653,160 entitled “Systems, Methods, and Computer Program Products for Interfacing Multiple Service Provider Trusted Service Managers and Secure Elements,” which is hereby incorporated by reference in its entirety.

An enterprise service bus (ESB) is an architecture model for implementing the interactions and communications between entities (e.g., mobile device, SP TSMs, central TSM).

Traditionally, OTA programming (e.g., communications using a wireless medium) capabilities include the ability to request certain action to be taken on a secure element associated with a mobile device. For example, requested actions may include commands to set up a service account and manage a service account. Generally, however, information stored on a mobile phone may pose data security concerns (e.g., the information may be at risk for exposure to third parties).

One technical challenge involves securing a payment transaction at a POS terminal made via a mobile device.

Another technical challenge involves leveraging the cloud-based secure store to increase efficiency and improve operability in processing payment transactions using the cloud-based secure store.

### BRIEF DESCRIPTION

The present invention provides systems, methods, and computer program products for interfacing with and providing a cloud-based secure storage.

In one embodiment, a system (e.g., CLF proxy) for interfacing with a cloud-based secure storage includes a cloud-based secure storage external to a NFC device and a processor coupled to the NFC device. The processor receives, from an external terminal (e.g., POS), a request to process a contactless transaction, and determines whether the request includes a request for security-critical information. If it is determined that the request includes a request for security-critical information, the processor communicates the request to the cloud-based secure storage and transmits a response to the external terminal based on the request.

In another embodiment, a method for interfacing with a cloud-based secure storage includes receiving, from an external terminal, a request to process a contactless transaction and determining whether the request includes a request for security-critical information. If it is determined that the request includes a request for security-critical information, the method includes communicating the request to a cloud-based secure storage and transmitting a response to the external terminal based on the request.

In another embodiment, a non-transitory computer-readable medium having stored thereon sequences of instructions, the sequences of instructions including instructions, which, when executed by a computer system cause the computer to: receive, from an external terminal, a request to process a contactless transaction and determine whether the request includes a request for security-critical information, wherein if it is determined that the request includes a request for security-critical information, communicate the request to a cloud-based secure storage, and transmit a response to the external terminal based on the request.

### BRIEF DESCRIPTION OF THE DRAWINGS

The features and advantages of the present invention will become more apparent from the detailed description set forth below when taken in conjunction with the following drawings.

FIG. 1 is a diagram of a system for interfacing between service providers and mobile devices having secure elements according to an exemplary embodiment.

FIG. 2 is a diagram of a system for providing a cloud-based secure storage according to an exemplary embodiment.

FIGS. 3A and 3B are sequence diagrams illustrating sequences for interfacing between a mobile device and a cloud-based secure storage having a cloud-based payment card according to an exemplary embodiment.

FIG. 4 is a block diagram of an exemplary system useful for implementing the present invention.

FIG. 5 is a diagram of a system for providing token processing, according to an exemplary embodiment.

FIG. 6 is a flow chart illustrating a process for providing token processing, according to an exemplary embodiment.

FIG. 7 is a sequence diagram showing example interactions for providing token processing, according to an exemplary embodiment.

### DETAILED DESCRIPTION

### Overview

The example embodiments presented herein describe systems, methods, and computer program products for interfacing with and providing a cloud-based secure storage.

The terms “applet,” “application,” and/or the plural form of these terms are used interchangeably herein to refer to an applet (functioning independently or in conjunction with other applets) or set or subset of instructions or code, which when executed by one or more processors (e.g., in a mobile device, card reader, terminal, point of sale (POS) system, or server) causes the processor(s) to perform specific tasks. It should be understood that “applets” as used herein refers to generic or instances of applets on a secure element.

In one exemplary embodiment, the SP or issuer may transmit a request to the ESB to trigger an action to be performed on a cloud-based secure store. In response, an interceptor manages the SP or issuer preferences and routes the creation of secure domain and applets within a UICC SE or a cloud-based SE (e.g., cloud-based secure storage). This approaches allows the issuer to personalize data on the cloud-based secure store and provides an option to orchestrate calls to the cloud-based SE or to a secure element on the mobile device so that the user may switch from device to device and still have his or her credentials stored on the cloud.

As a result, users of mobile devices may complete some payment transactions using information stored on their mobile devices even when network communications are not available or when access to remotely-stored account information is otherwise not available, thus providing a faster response back to the POS. Moreover, by leveraging cloud storage, security concerns regarding sensitive information stored on a mobile device can be minimized or eliminated.

### System

### A. System Overview

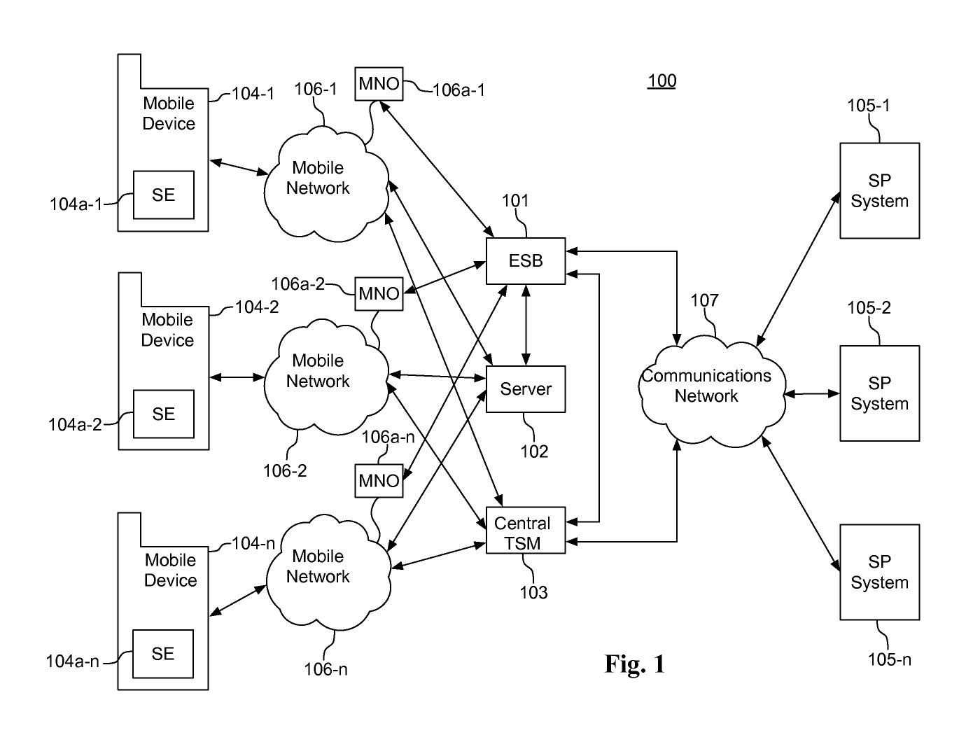

FIG. 1 is a diagram of an exemplary system 100 for interfacing between service providers and mobile devices having secure elements according to an exemplary embodiment. As shown in FIG. 1, system 100 includes an ESB 101, which is communicatively coupled to a server 102 (which may also be referred to as a “wallet server” or “mobile wallet server”) and a central TSM 103.

In exemplary embodiments described herein, the central TSM 103 includes a processor and a memory (e.g., a database) and handles, for example, the installation and upgrading of services on secure elements.

The ESB 101 is communicatively coupled to SP systems 105-1, 105-2, . . . , 105-n (collectively “105”) via a communications network 107. Communications network 107 may be a virtual private network (VPN), a network using Transmission Control Protocol/Internet Protocol (TCP/IP) standards, or the like.

Generally, the ESB 101 manages interactions between SP systems 105 and mobile devices 104-1, 104-2, . . . , 104-n (collectively “104”), and grants the SP systems the ability to efficiently and securely communicate with the mobile devices 104 in order to, for example, upgrade a service without the need for directly communicating with each of the mobile devices 104.

In an example embodiment, the ESB 101 is hardware and/or software that is implemented to serve as an intermediary between SP systems 105 and mobile devices 104, for example, for processing requests (e.g., to upgrade a service) within a mobile commerce system.

In another example embodiment, the processes and functions described below with reference to an ESB (e.g., ESB 101) can be performed by a TSM (e.g., central TSM 103).

The server 102 and the central TSM 103 are each communicatively coupled to mobile devices 104 via corresponding mobile networks 106-1, 106-2, . . . , 106-n (collectively “106”). Each of the mobile networks 106 is operated by a corresponding MNO 106a-1, 106a-2, . . . , 106a-n (collectively “106a”).

The server 102 and the central TSM 103 communicate with mobile devices 104 via the mobile networks 106, using security protocols such as Global Platform secure channel protocol, SSL, TLS, or the like. Mobile networks 106 may be mobile phone cellular networks, radio networks, or the like.

In one exemplary embodiment, the ESB 101, server 102 and central TSM 103 may be part of a single system architecture managed by a single provider, such as a mobile wallet provider.

Each of the mobile devices 104 includes a corresponding secure element 104a-1, 104a-2, . . . , 104a-n (collectively “104a”), and a corresponding mobile wallet (not shown).

A mobile wallet is an application stored in a non-transitory memory of a mobile device including instructions which, when executed by the processor of a mobile device, cause the mobile device to act as an instrument, for example, for processing contactless transactions or for processing commerce information such as offer or loyalty information. A mobile wallet and a corresponding secure element may communicate using International Organization for Standardization (ISO) 7816 commands, in order to conduct contactless transactions.

Each of the mobile devices 104 may include a user interface such as a display for receiving inputs from and outputting data to a user.

### B. Cloud-Based Secure Store

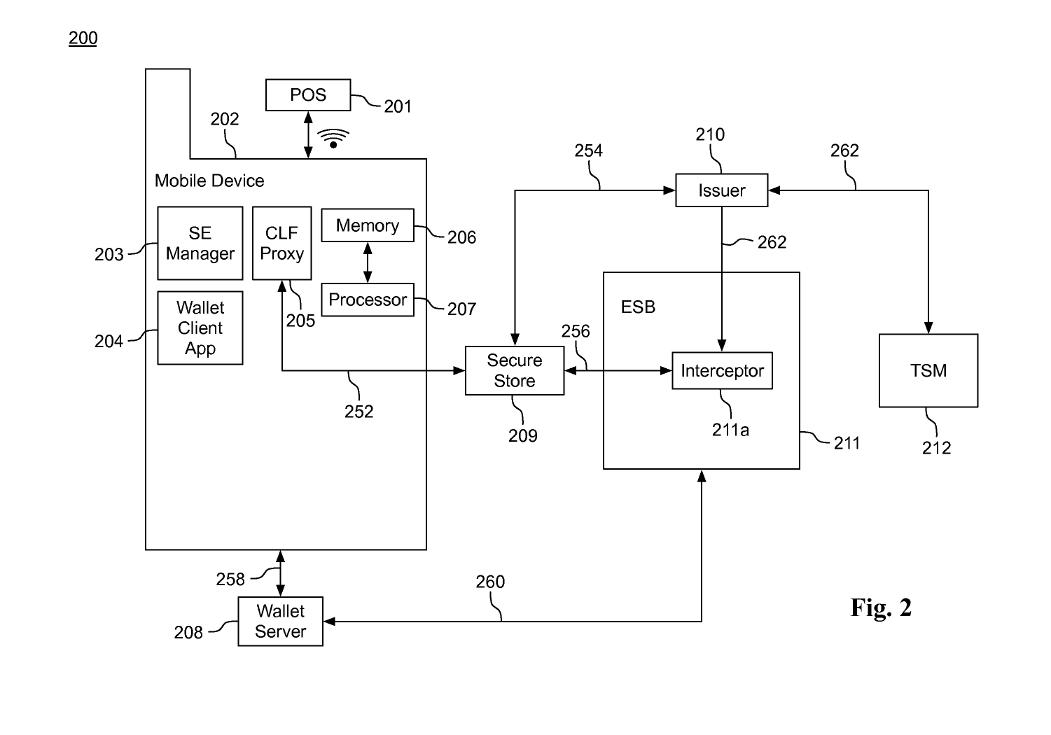

FIG. 2 depicts a diagram 200 of a system for providing a secure store 209 for use in remote transactions according to an exemplary embodiment. The secure store is implemented, for example, as a cloud-based or virtual secure element external to the mobile device (e.g., via host card emulation (HCE)).

As shown in FIG. 2, mobile device 202 (e.g., FIG. 1, mobile device 104-1) includes secure element manager library (SE manager library) 203, a wallet client application 204, a contactless front end (CLF) proxy 205, a memory 206, and a processor 207. Although not illustrated in FIG. 2, the mobile device 202 may also include a user interface such as a display.

Wallet client application 204 on the mobile device 202 provides an interface for receiving inputs and displaying outputs. Wallet client application 204 interacts with a wallet server 208 to, for example, update information and manage items that the wallet client application presents to the user.

In one exemplary embodiment, wallet client application 204 includes instructions which, when executed by the processor 207 of the mobile device 202, causes the mobile device to act as an instrument, for example, for processing transactions such as contactless transactions (e.g., NFC contactless payments).

CLF proxy 205 provides a pass-through for authorization requests from secure store 209 to POS 201. CLF proxy 205 resides within the wallet client application 204 and provides the wallet client application 204 with means to communicate with other systems (e.g., payment terminal 201, secure store 209) using, for example, high-level application programming interfaces (APIs). CLF proxy 205 maintains the logic and communication between the mobile wallet and POS devices.

Secure store 209 includes a data store containing wallet or credit card related records. Secure store 209 handles “deploy service” and personalization calls from the issuer (e.g., at 254).

Secure store 209 may include a hardware security module (HSM) in which credentials (e.g., payment credentials) and personalization data, for example, may be stored and encrypted. Security-critical information such as payment credentials associated with a credit card is handled in secure store 209 instead of on the mobile phone. Limited use credentials are delivered to the mobile device 202 in advance to enable contactless transactions to take place.

Data stored on the mobile device is vulnerable. Thus, HCE restricts the storage of sensitive data (e.g., payment information and credentials) to cloud-based databases. These databases are managed to a high security standard, exceeding common security (e.g., Payment Card Industry Data Security Standard (PCI DSS)). Non-security-critical information may stay on the secure element on the mobile device 202 (e.g., payment selector application, loyalty card information).

Interceptor 211a resides within the ESB 211 framework. The role of the interceptor is to route NFC commands from an issuer. Two possible communication paths are provided. Transactions are processed in accordance with the issuer preferences. Based on a setup with a particular issuer 210 (e.g., a SP), the interceptor 211a functions to determine whether to route requests from the issuer 210 to a secure element on the mobile device or whether to route the requests to secure store 209. Such transactions or processes can, for example, include transactions based on payment using credit, debit, rewards, gift card, or voucher accounts.

In an example embodiment, interceptor 211 intercepts “install service” and “manage service” calls and routes them to secure store 209 if the origination of the call is from an issuer that opted-in to this solution. All other calls from the issuer such as “deploy service” will route directly to secure store 209.

In an example embodiment, when a user wants to add a card, a request is sent to issuer 210. Issuer 210 initiates a set up a service account (SSA) call 262, which comes through to ESB 211. Interceptor 211a reviews the preferences of issuer 210 and makes a determination as to whether to route the call to a secure element on the mobile device (e.g., SIM-based SE) or to route the call to secure store 209 (e.g., cloud-based SE). The determination is based on the preferences of the issuer making the call.

For example, when issuer 210 has preferences to perform personalization on a cloud-based secure store, interceptor 211a routes the call to secure store 209. At 256, secure store 209 responds to interceptor 211a with an SSA Callback. The SSA Callback includes information issuer 210 needs in order to go through key rotation. The SSA Callback is sent to the issuer at 258, indicating that everything is set up, a service version is installed, and provides the particulars of a security domain and AID, making the application usable by a user for payment.

Once the issuer has interacted with secure store 209, a communication channel is established directly (e.g., at 254) between the issuer 210 and the secure store 209. In turn, the issuer 210 may interact directly with secure store 209 to perform personalization and activation of a service, for example, because the issuer will know the AID of the card.

At 252, CLF proxy 205 retrieves information securely from secure store 209 and presents the information in a proper format (e.g., Track 1 data, Track 2 data, or EMV (Europay, Mastercard and Visa) data) based on the payment type at the Point Of Sale (POS) terminal 201.

### Process

### C. Interfacing with a Cloud-Based Secure Storage

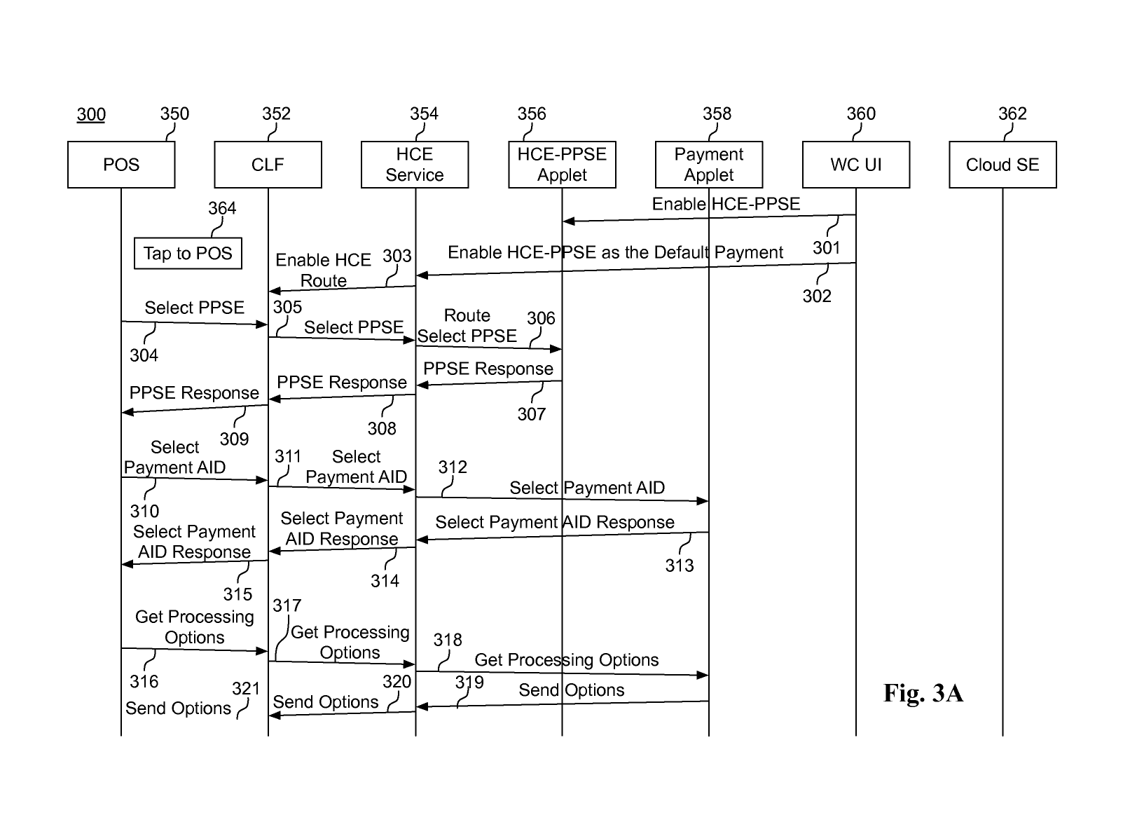

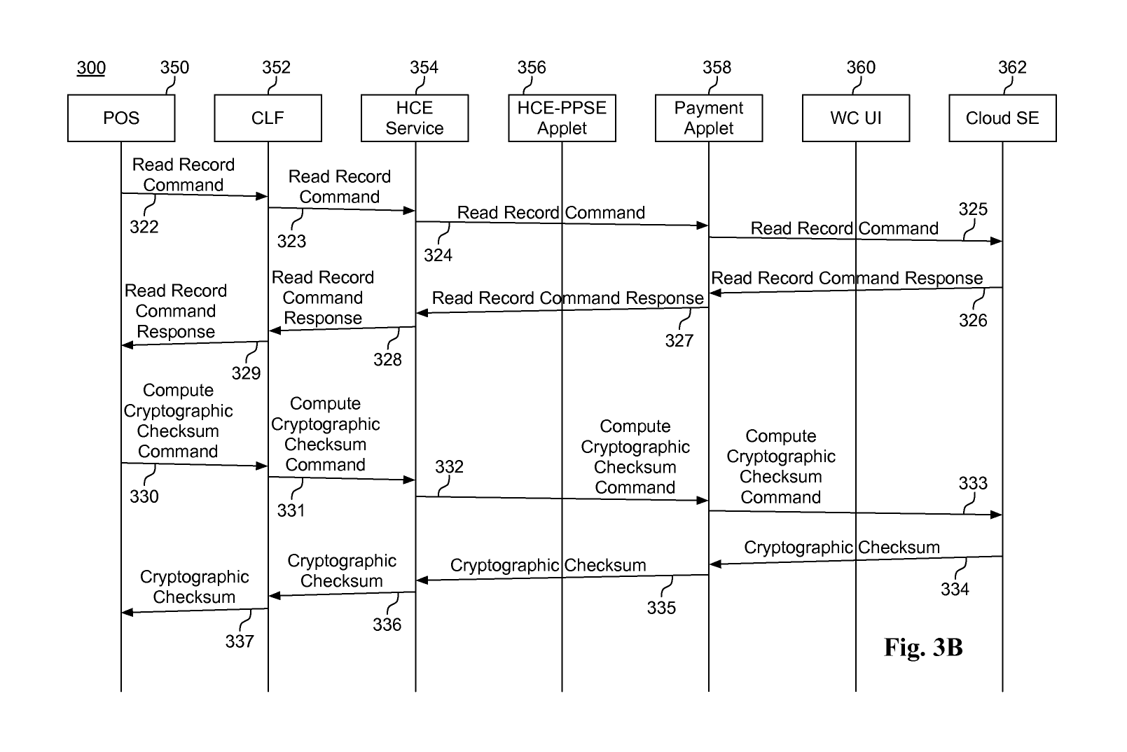

FIGS. 3A and 3B are sequence diagrams illustrating sequences for interfacing between a mobile device and a cloud-based secure storage having a cloud-based payment card according to an exemplary embodiment.

When an action is to be performed on a cloud-based secure element, an HCE service is implemented.

In one exemplary embodiment shown in FIG. 3A, the action includes a request to make a payment using a cloud-based payment card. For example, a payment transaction is initiated when a user selects a payment card on a wallet client user interface (WC UI) 360. At step 301, HCE-PPSE applet 356 is loaded with the AID of the card selected by the user. Additionally, at step 302, WC UI enables the HCE service as the default payment service. At step 303, CLF 352 is conFIG.d to enable HCE routing.

When an NFC-enabled device is presented to (e.g., tapped on) a POS terminal 350, a command is sent from the POS terminal 350 to the CLF proxy 352, which is in turn relayed to HCE service 354.

In one exemplary embodiment shown in FIG. 3A, at steps 304-306, the command sent from POS terminal 305 to HCE-PPSE applet 356 includes selecting a payment card (e.g., Select PPSE). At steps 307-309, a response (e.g., PPSE Response) is sent from HCE-PPSE applet 356 to POS terminal 350, which includes the AID of the selected payment card.

At steps 310-312, POS terminal 350 sends a command to select the AID of the payment card that was selected by the user via WC UI 360 (e.g., Select Payment AID), which is routed to respective payment applet 358 (e.g., MasterCard applet). Payment applet 358 is used to make contactless payments using the mobile wallet. At steps 313-315, payment applet 358 sends a response (e.g., Select Payment AID Response) to POS terminal 350 and awaits a further command.

At steps 316-318, POS terminal 350 sends a command to receive processing options which POS terminal 350 is allowed to handle (e.g., Get Processing Options). For example, processing options may include whether transactions may be processed online or offline. At steps 319-321, payment applet 357 responds with processing options (e.g., Send Options) for processing a transaction.

In some instances, however, payment applet 358 will not have the information requested by POS terminal 350, for example, when sensitive (e.g., security critical) information is requested.

In such a case, as in an exemplary embodiment shown in FIG. 3B, a command requesting a response that includes sensitive information is sent from POS terminal 350 to cloud SE (e.g., cloud-based secure store) 362 for retrieval of the sensitive information. At steps 322-235, for example, a command to read a record (e.g., Read Record Command) is sent from POS terminal 350 to payment applet 358. Payment applet 358 will not have the sensitive information (e.g., credentials of a user) required to respond, so it relays the read record command to cloud SE 362. At steps 326-329, a response (e.g., Read Record Command Response) including the sensitive service provider data, such as transaction data (e.g., account number, account verification code, expiration date, address information, or other matter of verification) associated with a service provider account issued to a consumer, is returned to POS terminal 350.

Similarly, at steps 330-333, a command to compute a cryptographic checksum (e.g., Compute Cryptographic Checksum) is sent from POS terminal 350 to payment applet 358. Payment applet 358 will not have the sensitive information (e.g., algorithm) required to respond, so it relays the cryptographic checksum command to cloud SE 362. At steps 334-337, cloud SE 362 calculates the cryptogram and provides a response including the cryptographic checksum to POS terminal 350.

### D. Example Computer-Readable Implementation

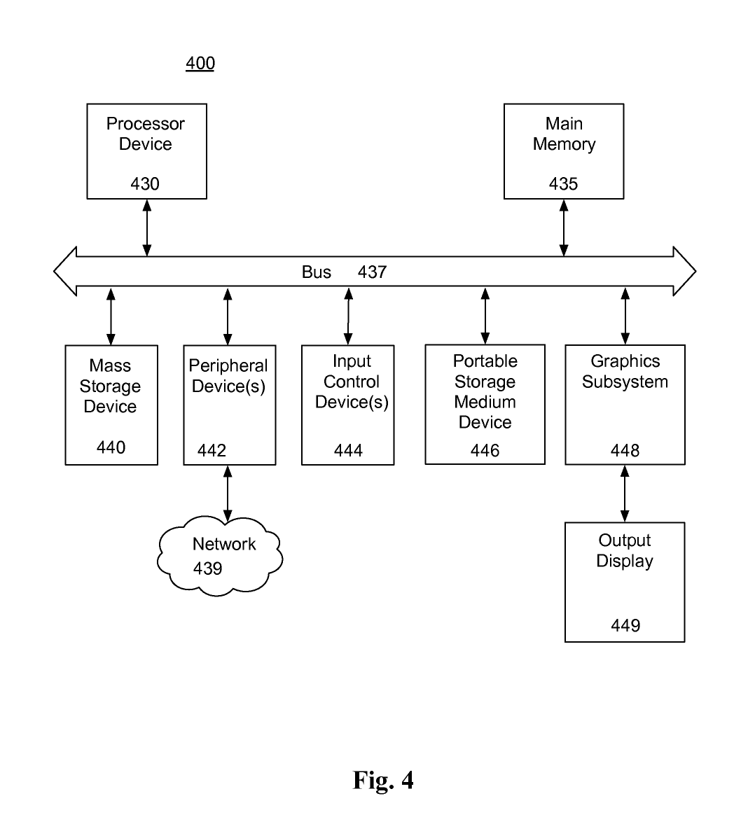

FIG. 4 is a block diagram of a general and/or special purpose computer 400, in accordance with some of the example embodiments of the invention. The computer 400 may be, for example, a user device, a user computer, a client computer and/or a server computer, among other things.

The computer 400 may include without limitation a processor device 430, a main memory 435, and an interconnect bus 437. The processor device 430 may include without limitation a single microprocessor, or may include a plurality of microprocessors for configuring the computer 400 as a multi-processor system. The main memory 435 stores, among other things, instructions and/or data for execution by the processor device 430. The main memory 435 may include banks of dynamic random access memory (DRAM), as well as cache memory.

The computer 400 may further include a mass storage device 440, peripheral device(s) 442, portable storage medium device(s) 446, input control device(s) 444, a graphics subsystem 448, and/or an output display 449. For explanatory purposes, all components in the computer 400 are shown in FIG. 4 as being coupled via the bus 437. However, the computer 400 is not so limited. Devices of the computer 400 may be coupled via one or more data transport means. For example, the processor device 430 and/or the main memory 435 may be coupled via a local microprocessor bus. The mass storage device, 440, peripheral device(s) 442, portable storage medium device(s) 446, and/or graphics subsystem 448 may be coupled via one or more input/output (I/O) buses. The mass storage device 440 may be a nonvolatile storage device for storing data and/or instructions for use by the processor device 430. The mass storage device 440 may be implemented, for example, with a magnetic disk drive or an optical disk drive. In a software embodiment, the mass storage device 440 is conFIG.d for loading contents of the mass storage device 440 into the main memory 435.

The portable storage medium device 446 operates in conjunction with a nonvolatile portable storage medium, such as, for example, a compact disc read only memory (CD-ROM), to input and output data and code to and from the computer 400. In some embodiments, the software for storing an internal identifier in metadata may be stored on a portable storage medium, and may be inputted into the computer 400 via the portable storage medium device 446. The peripheral device(s) 442 may include any type of computer support device, such as, for example, an input/output (I/O) interface conFIG.d to add additional functionality to the computer 400. For example, the peripheral device(s) 442 may include a network interface card for interfacing the computer 400 with a network 439.

The input control device(s) 444 provide a portion of the user interface for a user of the computer 400. The input control device(s) 444 may include a keypad and/or a cursor control device. The keypad may be conFIG.d for inputting alphanumeric characters and/or other key information. The cursor control device may include, for example, a mouse, a trackball, a stylus, and/or cursor direction keys. In order to display textual and graphical information, the computer 400 may include the graphics subsystem 448 and the output display 449. The output display 449 may include a cathode ray tube (CRT) display and/or a liquid crystal display (LCD). The graphics subsystem 448 receives textual and graphical information, and processes the information for output to the output display 449.

Each component of the computer 400 may represent a broad category of a computer component of a general and/or special purpose computer. Components of the computer 400 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the FIG.s are presented for example purposes only. The architecture of the example embodiments presented herein is sufficiently flexible and configurable, such that it may be utilized and navigated in ways other than that shown in the accompanying FIG.s. Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

### E. Token System

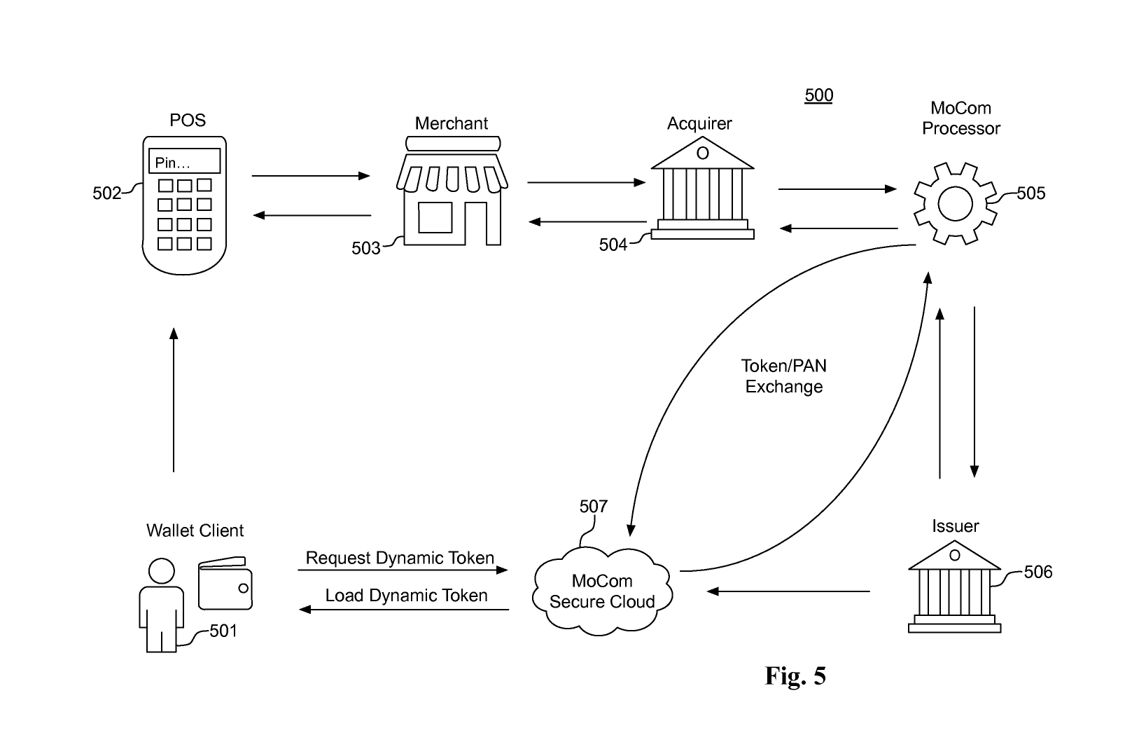

FIG. 5 is a diagram of a system 500 for providing token processing according to an exemplary embodiment. As shown in FIG. 5, system 500 includes a wallet client 501, POS 502, merchant 503, acquirer 504, MoCom (Mobile processor 505, issuer 506, and MoCom secure cloud 507.

Wallet client 501 is a wallet client application stored on a device, e.g., a mobile device such as a cellular phone, tablet, or the like. For purposes of simplicity, wallet client 501 will hereafter be described in terms of storage and execution on a mobile device, but it should be understood that other types of devices could be used, such as a laptop, desktop computer, etc.

Wallet client 501 includes instructions which, when executed by the processor of the mobile device, cause the mobile device 501 to act as an instrument, for example, for processing transactions such as contactless payments. It should be understood that these and other communications between devices may include communications with or through other intervening systems, hardware, and/or software. Wallet client 501 also includes (e.g., uses, operates on, is associated with) data which may be stored on the memory of the mobile device and/or on a secure element (SE) associated with the mobile device. In that regard, example aspects of a secure element are described in U.S. patent application Ser. No. 13/901,188, entitled “Systems, Methods, And Computer Program Products For Providing A Contactless Protocol”, the contents of which are incorporated herein by reference.

POS 502 is a location where a user conducts a transaction, e.g., a “check-out” terminal at a retailer. A terminal at POS 502 might be equipped with a near field communication (NFC) enabled reader module or the like. Although only one POS terminal is shown FIG. 5, it should be understood that POS 502 may comprise any number of terminals, or that well as multiple POS might exist in the same physical location.

Merchant 503 is a system, platform, computer architecture or the like, managed by a merchant (e.g., business, retailer) for managing mobile commerce transactions and for creating and processing merchant offers. In one exemplary embodiment, a merchant system creates loyalty offers to be certified, conFIG.d, stored and/or distributed to wallet client 501.

Acquirer 504 is a system, platform, computer architecture or the like, managed by an acquirer (or acquiring bank), for example, for processing remote transactions including remote payments. In one example, an acquirer is a bank or financial institution that processes transactions such as payments for goods or services, on behalf of a merchant, e.g., merchant 503. In one exemplary embodiment, acquirer 504 communicates with a service provider (e.g., issuer 506) systems to exchange funds on behalf of a merchant during the processing of a remote transaction.

Mobile Commerce (hereafter “MoCom”) processor 505 is a system, platform, computer architecture or the like which facilitates payment processing using a token. In one aspect, MoCom processor 505 receives a token, and queries the token generator (e.g., MoCom secure cloud 507, as discussed below) with the token. The token generator returns stored card credentials corresponding to wallet client 501 (e.g., stored payment card credentials) to MoCom processor 505, which completes the POS payment transaction by interfacing the returned credentials to issuer 506.

Issuer 506 is a system, platform, computer architecture or the like that provides services to customers or consumers. Examples of service providers include account-issuing entities such as banks, merchants, card associations, marketing companies, and transit authorities. A service may be an activity, capability, functionality, work, or use that is permitted or provided by a service provider, such as a payment service, credit, debit, checking, gift, offer or loyalty service, transit pass service, and the like. For example, in the example shown in FIG. 5, issuer 506 may be a bank which ultimately debits a user's account for a purchase at POS 502, using a “card” stored in wallet client 501.

MoCom secure cloud 507 is a system, platform, computer architecture or the like which securely stores and process payment information as per, e.g., GlobalPlatform Card Specification Versions 2.1.1 and 2.2 (hereinafter “Global Platform”) specifications. Typical data stored in such a system include payment credentials, issuer secure domain, issuer keys, and the like. MoCom secure cloud 507 secures payment credentials sent by, e.g., issuer 506, and adheres to Global Platform Specifications to manage the lifecycle of the applications and information within its secure store. MoCom secure cloud 507 also provides interfaces to a contactless frontend (CLF) proxy during a live payment of the wallet client 501 transaction at a terminal, e.g., POS 502. MoCom secure cloud 507 provides interfaces for issuer 506 to integrate and personalize payment credentials for wallet client 501 directly into a secure element in the cloud (“cloud SE”). The cloud SE adheres to the Global Platform Card Specification to create applications and secure domains within it to securely manage the data and lifecycle of the applications. As described more fully below, MoCom secure cloud 507 also acts as a token generator to generate a token using stored payment card credentials.

Briefly, as shown in FIG. 5, wallet client 501 requests a dynamic and temporary token from MoCom secure cloud 507, which acts as a token generator. MoCom secure cloud 507 generates the token using card credentials (e.g. payment card credentials corresponding to a user of wallet client 501), a time stamp, and a random number, and returns the token to wallet client 501. Wallet client 501 transmits the token to POS 502 during a payment transaction, and the token is routed by POS 502, merchant 503 and acquirer 504 to MoCom processor 505. MoCom processor 505 receives the token, and queries MoCom secure cloud 507 (the token generator) with the token. MoCom secure cloud 507 returns stored card credentials corresponding to wallet client 501 (e.g., stored payment card credentials) to MoCom processor 505, which then completes the POS payment transaction by interfacing the returned credentials to issuer 506. Each of these processes will be described in more detail below.

### F. Token Process

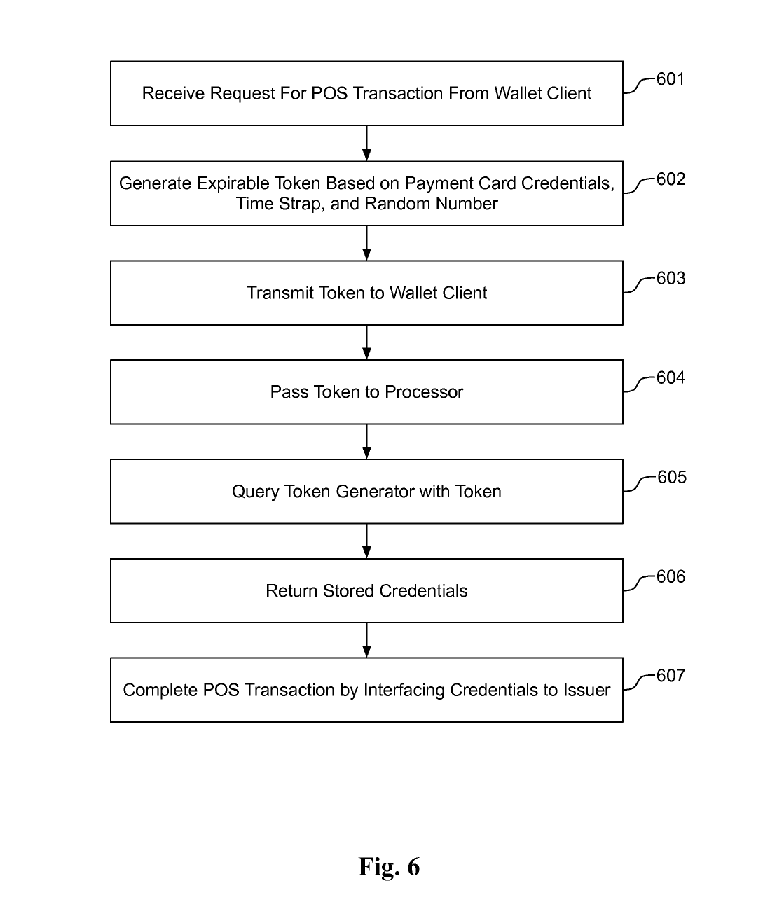

FIG. 6 is a flow chart illustrating a process 200 for token processing according to an example embodiment.

Briefly, in FIG. 6, payment card credentials associated with a wallet client application are stored. A request for a transaction is received from the wallet client application. An expirable token is generated based at least in part on the payment card credentials. The token is transmitted to the wallet client application. A query is received comprising information corresponding to a payment transaction and the generated token, the payment card credentials are returned in response to the query.

In that regard, the following process will be described in the context of MoCom secure cloud 507 acting as a token generator. However, the token generator could also be embodied in other elements of the mobile commerce system which include secure storage.

In step 601, a token generator (e.g., MoCom secure cloud 507) receives a request to make a POS transaction from a wallet client (e.g., wallet client 501). In that regard, MoCom secure cloud 507 stores payment card credentials associated with each wallet client, including wallet client 501, and may store such information prior to receiving the request to make the POS transaction (e.g., during a setup process).

In step 602, MoCom secure cloud 507 uses the stored payment card credentials associated with wallet client 501 to generate an expirable token having a predetermined and/or settable use period. Put another way, the token expires after a predetermined amount of time. The amount of time before expiration of the token can be set, e.g., by a user or administrator. The token is generated from the payment card credentials, a time stamp (e.g., a time stamp corresponding to a time of initiating generation of the token), and a random number (e.g. a random number generated subsequent to receiving the request).

In step 603, the token is transmitted from MoCom secure cloud 507 to wallet client 501 in response to the request.

In step 604, the token is passed to the token processor, i.e., MoCom processor 505. Specifically, the token is transmitted from wallet client 501 to POS 502, such as while conducting a contactless transaction, and is then passed to merchant 503 from POS 502. Merchant 503 then passes the token to acquirer 504, which passes the token to MoCom processor 505.

In that regard, additional information may also be exchanged along with or in addition to the token, and additional processes may be performed, e.g., at the POS. For example, wallet client may transmit tracking data of the wallet client to POS 502 during a purchase, and POS 502 may compute a cryptographic checksum to verify the identity of wallet client 501.

In step 605, upon MoCom processor 505 receiving the token, MoCom processor 505 queries MoCom secure cloud 507 (the token generator) with the received token, along with other information, such as information regarding the current transaction and the wallet client.

In step 606, in response to receiving the query, MoCom secure cloud 507 returns the stored card credentials corresponding to the token to MoCom processor 505.

In step 607, MoCom processor 505 completes the POS payment transaction by interfacing the returned card credentials to issuer 506. Thus, in one aspect, MoCom processor 505 acts as payment processing entity which communicates with an issuer of the payment card credentials.

### G. Token Example

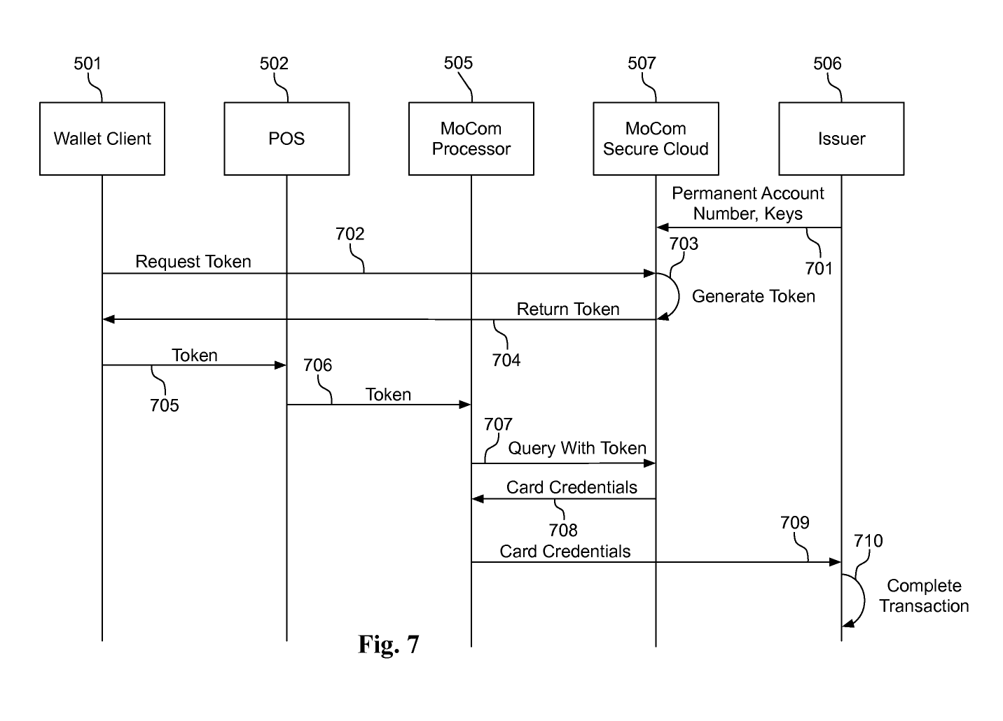

FIG. 7 is a sequence diagram showing example interactions for providing token processing, according to an exemplary embodiment.

In step 701, issuer 506 transmits payment credentials such as a permanent account number (PAN) and security keys to MoCom secure cloud 507. For example, after a setup or activation process of a payment card in a wallet client application, issuer 506 may transmit the PAN corresponding to the wallet client 501 to MoCom secure cloud 507 for secure storage of these credentials.

In step 702, wallet client 501 sends a token request to MoCom secure cloud 507.

In step 703, MoCom secure cloud 507 generates a token, as discussed above, an in step 704, MoCom secure cloud 507 transmits the token to wallet client 501.

In step 705, wallet client 501 transmits the token to POS 502 (e.g., at a retail terminal), and in step 706, POS 502 passes the token to MoCom processor 505.

In step 707, MoCom processor 505 sends a query with the token to MoCom secure cloud 507, and in step 708, MoCom secure cloud 507 returns card credentials corresponding to wallet client 501 to the MoCom processor 505.

In step 709, MoCom processor 505 transmits the card credentials to the issuer 506, which completes the transaction in step 710.

### Example Computer-Readable Implementation

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a CPU typically includes software resident on a storage media (e.g., a disk drive or memory card), which, when executed, directs the CPU in performing transmission and reception functions. The CPU software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

What is claimed is:

1. A system for interfacing with a cloud-based secure storage, the system comprising:
a cloud-based secure storage external to a NFC device; and
a processor coupled to the NFC device, the processor being operable to:
receive, from an external terminal, a request to process a contactless transaction,
determine that the request includes a request for security-critical information,
communicate the request to the cloud-based secure storage, and
transmit a response to the external terminal based on the request.

2. The system of claim 1, the processor being further operable to communicate the request to a secure element on the NFC device.

3. The system of claim 2, the processor is further operable to transmit to the external terminal at least a portion of non-security-critical data from a secure element on the NFC device.

4. The system of claim 3, wherein the non-security-critical data includes commerce data.

5. The system of claim 1, wherein the security-critical data includes encryption data.

6. The system of claim 1, wherein the system manages host-based card emulation (HCE) transactions.

7. A method for interfacing with a cloud-based secure storage, the method comprising:
receiving, from an external terminal, a request to process a contactless transaction;
determining that the request includes a request for security-critical information;
communicating the request to a cloud-based secure storage; and
transmitting a response to the external terminal based on the request.

8. The method of claim 7, further comprising a step of communicating the request from a secure element on the NFC device.

9. The method of claim 8, further comprising a step of transmitting to the external terminal at least a portion of non-security-critical data to a secure element on a NFC device.

10. The method of claim 9, wherein the non-security-critical data includes commerce data.

11. The method of claim 7, wherein the security-critical data includes encryption data.

12. The method of claim 7, further comprising a step of managing host-based card emulation (HCE) transactions.

13. A non-transitory computer-readable medium having stored thereon sequences of instructions, the sequences of instructions including instructions, which, when executed by a computer, cause the computer to:
receive, from an external terminal, a request to process a contactless transaction;
determine that the request includes a request for security-critical information;
communicate the request to a cloud-based secure storage; and
transmit a response to the external terminal based on the request.

14. The computer-readable medium of claim 13, the sequence of instructions further includes instructions which, when executed by the computer, cause the computer to communicate the request from a secure element on the NFC device.

15. The computer-readable medium of claim 14, the sequence of instructions further includes instructions which, when executed by the computer, cause the computer to transmit to the external terminal at least a portion of non-security-critical data to a secure element on a NFC device.

16. The computer-readable medium of claim 15, wherein the non-security-critical data includes commerce data.

17. The computer-readable medium of claim 13, wherein the security-critical data includes encryption data.

18. The computer-readable medium of claim 13, the sequence of instructions further includes instructions which, when executed by the computer, cause the computer to manage host-based card emulation (HCE) transactions.

19. The system of claim 5, wherein the encryption data comprises an account number of a service provider account, an account verification code of a service provider account, and an expiration date of a service provider account.

20. The method of claim 7, further comprising:
storing payment card credentials associated with a wallet client application;
receiving a request for a transaction from the wallet client application;
generating an expirable token based at least in part on the payment card credentials;
transmitting the token to the wallet client application;
receiving a query comprising information corresponding to a payment transaction and the generated token; and
returning the payment card credentials in response to the query.
